(19) United States
(12) Patent Application Publication
(10) Pub. No.: US 2025/0199195 A1
(43) Pub. Date: Jun. 19, 2025

(54) AUTOMATIC DIP REFINEMENT

(71) Applicant: Halliburton Energy Services, Inc., Houston, TX (US)

(72) Inventors: Zheguang ZOU, Singapore (SG); Vytautas USAITIS, Houston, TX (US); Robert P. DARBE, Tomball, TX (US)

(73) Assignee: Halliburton Energy Services, Inc., Houston, TX (US)

(21) Appl. No.: 18/545,686

(22) Filed: Dec. 19, 2023

(51) Int. Cl. G01V 8/02; G06T 5/10

(52) U.S. Cl. CPC G01V 8/02; G06T 5/10; G06T 2207/20061; G06T 2207/30181

(57) ABSTRACT

Aspects of the subject technology relate to systems and methods of refining manually selected values of physical parameters associated with a manual dip of an azimuthal wellbore image. The method includes perturbating one or more of the manually selected values, selecting a portion of the azimuthal wellbore image based in part on the perturbated values, and performing a Hough transform of the selected portion of the azimuthal wellbore image into a parameter space comprising a plurality of points, thereby determining respective cumulative counts for one or more of the plurality of points in the parameter space. The method also includes selecting a point based in part on its respective cumulative count, calculating refined values of the physical parameters associated with the selected point, and returning the refined values as the physical parameters of a refined dip.

### TECHNICAL FIELD

The present technology pertains to refining a manual dip using a transformation of a portion of a azimuthal wellbore image from physical space to a parameter space.

### BACKGROUND

“Dip picking” is the process of identifying sinusoidal patterns in the boundaries between beds of a formation from azimuthal borehole imaging logs. The process can be performed manually by geologists or geosteering engineers. However, manual dip picking is time-consuming, tedious, and subjective.

### BRIEF DESCRIPTION OF THE DRAWINGS

In order to describe the manner in which the features and advantages of this disclosure can be obtained, a more particular description is provided with reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings.

FIG. 1 is a schematic diagram of an example logging-while-drilling (LWD) wellbore operating environment, in accordance with various aspects of the subject technology.

FIGS. 2A-2C illustrate a 3D bed boundary represented as a 2D sinusoid in an azimuthal borehole image, in accordance with various aspects of the subject technology.

FIG. 3 illustrates beds and boundaries in an example formation, in accordance with various aspects of the subject technology.

FIGS. 4A-4B illustrate examples of manually selected dips and Hough transformation, in accordance with various aspects of the subject technology.

FIG. 5 is a flow chart of an exemplary process for automatically assisting in identifying a dip, in accordance with various aspects of the subject technology.

FIGS. 6A-6B illustrate the step of identifying sinusoids in parameter space and selecting the maximum amplitude sinusoid, in accordance with various aspects of the subject technology.

FIGS. 7A-7B illustrate experimental results of improvements from manually picked dips to an automatically refined dip, in accordance with various aspects of the subject technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the principles disclosed herein. The features and advantages of the disclosure can be realized and obtained by means of the instruments and combinations particularly pointed out in the appended claims.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

During oil exploration and other drilling activities, dip picking is performed to identify the boundaries between beds of a formation from azimuthal borehole imaging logs. The task of dip picking can be performed manually by visual inspection and annotation of the borehole images. This process is very time-consuming and requires a qualified team of experts to annotate a whole well dataset. For example, it may take a couple of man-days to manually pick the dips for all bed boundaries of a typical wellbore. Conventional automatic dip picking methods have proven to be effective in reducing time and labor effort in picking dip boundaries. In the current state, however, they are not as reliable as humans in processing some challenging dips from high-angle and horizontal wellbore azimuthal image data. Disclosed herein are automatic dip picking systems and methods to assist manual dip picking in a real-time, interactive manner. Some conventional automatic dip picking processes convert the entire azimuthal wellbore image to a parameter space, for example using a Hough transformation, although this carries a large computation burden that makes it effectively unusable for assisting manual dip picking in real-time during the drilling operation.

The systems and methods disclosed herein seek to augment the manual dip picking rather than perform a completely automatic process. In practice, humans are efficient and accurate in identifying sinusoidal patterns but are not good at positioning a sinusoidal curve to perfectly match the patterns of the bed boundaries. The disclosed systems and methods speed up this “positioning” process, which is the most time-consuming part of manual dip picking. The disclosed refinement reduces the computational burden sufficient to make the disclosed refined dip picking into a real-time process. The disclosed systems and methods also reduce the inherent bias in manual dip picking, as no two geologists pick the same dip.

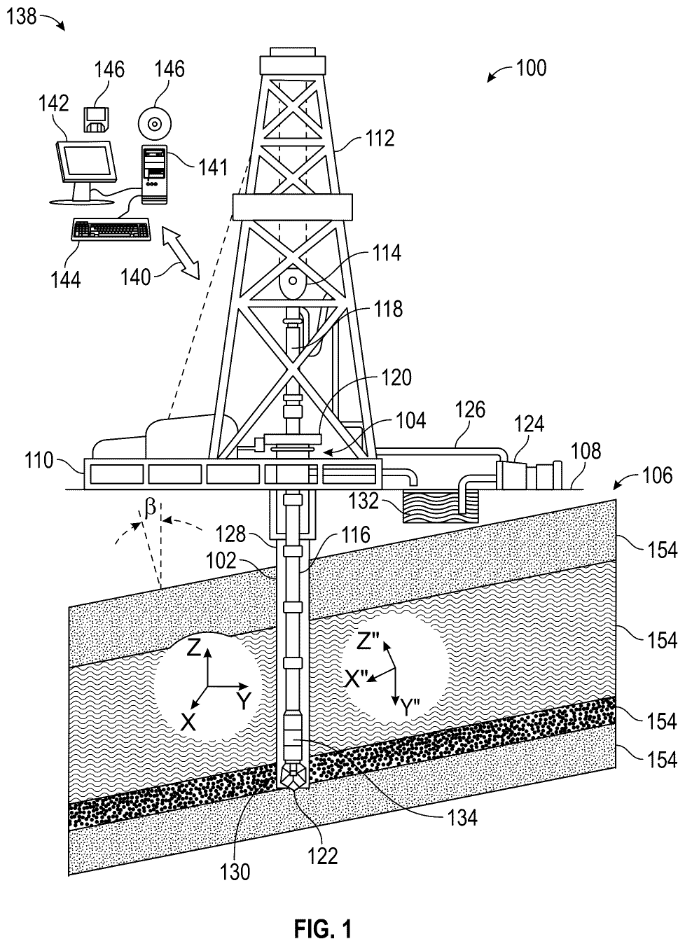

FIG. 1 illustrates a drilling system 100. As illustrated, borehole 102 may extend from a wellhead 104 into a subterranean formation 106 from a surface 108. Generally, borehole 102 may include horizontal, vertical, slanted, curved, and other types of borehole geometries and orientations. Borehole 102 may be cased or uncased. In examples, borehole 102 may include a metallic member. In certain embodiments, the metallic member is one of a casing, liner, tubing, or other elongated steel tubular disposed in borehole 102.

As illustrated, borehole 102 may extend through subterranean formation 106. Borehole 102 may extend generally vertically into the subterranean formation 106, however borehole 102 may extend at an angle through subterranean formation 106, such as horizontal and inclined boreholes. It should further be noted that while FIG. 1 depicts a land-based operation, those skilled in the art may recognize that the principles described herein are equally applicable to subsea operations that employ floating or sea-based platforms and rigs, without departing from the scope of the disclosure.

In this example, drilling platform 110 supports a derrick 112 having a traveling block 114 for raising and lowering drill string 116. Drill string 116 may include, but is not limited to, drill pipe and coiled tubing, as generally known to those skilled in the art. A kelly 118 may support drill string 116 as it may be lowered through a rotary table 120. A drill bit 122 is attached to the distal end of drill string 116 and may be driven either by a downhole motor and/or via rotation of drill string 116 from surface 108. In certain embodiments, drill bit 122 comprises one or more of roller cone bits, PDC bits, natural diamond bits, any hole openers, reamers, coring bits, and the like. As drill bit 122 rotates, it creates and extends borehole 102 that penetrates various beds of subterranean formation 106. A pump 124 circulates drilling fluid through a feed pipe 126 and through kelly 118, downhole through interior of drill string 116, through orifices in drill bit 122, back to surface 108 via annulus 128 surrounding drill string 116, and into a retention pit 132.

Drill string 116 begins at wellhead 104 and traverses borehole 102. Drill bit 122 is attached to a distal end of drill string 116 and may be driven, for example, either by a downhole motor and/or via rotation of drill string 116 from surface 108. Drill bit 122 is part of bottom hole assembly (BHA) 130 at distal end of drill string 116. In certain embodiments, BHA 130 further includes tools for look-ahead resistivity applications. As will be appreciated by those of ordinary skill in the art, BHA 130 can be part of either a measurement-while drilling (MWD) or a logging-while-drilling (LWD) system.

In certain embodiments, BHA 130 comprises one or more of any number of tools, transmitters, and/or receivers to perform downhole measurement operations. In certain embodiments, BHA 130 includes a measurement assembly 134. In certain embodiments, measurement assembly 134 comprises azimuthal borehole instrumentation for detecting bed boundaries and determining one or more dip angles at one or more depths. In certain embodiments, measurement assembly 134 comprises a modular resistivity tool with tilted antennas. In certain embodiments, measurement assembly 134 comprises other azimuthal measurement tools such as density imaging tools such as azimuthal litho-density tools. measurement assembly 134 comprises, the azimuthal borehole instrumentation measures the inclination angle, the horizontal angle, and the azimuthal angle (also known as the rotational or “tool face” angle) of the LWD tools. Inclination angle is the deviation from vertically downward, the horizontal angle is the angle in a horizontal plane from true North, and the tool face angle is the orientation (rotational about the tool axis) angle from the high side of the borehole. In certain embodiments, azimuthal borehole instrumentation measurements comprise three-axis accelerometer measurements of the earth's gravitational field vector relative to the tool axis and a point on the circumference of the tool called the “tool face scribe line” that is parallel to the tool axis. From this measurement, inclination and tool face angle of the LWD tool may be determined. In certain embodiments, a three-axis magnetometer measures the earth's magnetic field vector in a similar manner. From the combined magnetometer and accelerometer data, the horizontal angle of the LWD tool can be determined. In certain embodiments, a gyroscope or other form of inertial sensor is incorporated to perform position measurements and further refine the orientation measurements.

In certain embodiments, downhole sensors on measurement assembly 134 are coupled to information handling system 138. Formation 106 may comprise a series of formation beds 154 dipping at an angle. A first (x, y, z) coordinate system associated with the sensors of measurement assembly 134 is shown, and a second coordinate system (x″, y″, z″) associated with the formation beds 154 are shown in FIG. 1. The bed coordinate system has the z″ axis perpendicular to the bedding plane, has the y″ axis in a horizontal plane, and has the x″ axis pointing “downhill.” The angle between the z-axes of the two coordinate systems is referred to as the “dip” and is shown in FIG. 1 as the angle β.

In certain embodiments, BHA 130 is connected to and/or controlled by information handling system 138, which may be disposed on surface 108 or downhole in BHA 130. Processing of information recorded may occur downhole and/or on surface 108. Processing occurring downhole may be transmitted to surface 108 to be recorded, observed, and/or further analyzed. Additionally, information recorded on information handling system 138 disposed downhole may be stored until BHA 130 may be brought to surface 108. In certain embodiments, information handling system 138 communicates with BHA 130 through a communication line (not illustrated) disposed in (or on) drill string 116. In certain embodiments, wireless communication is used to transmit information back and forth between information handling system 138 and BHA 130. In certain embodiments, information handling system 138 transmits information to BHA 130 and receives as well as process information recorded by BHA 130. In certain embodiments, a downhole information handling system (not illustrated) includes a microprocessor, or equivalent circuitry, for receiving and processing signals from BHA 130. In certain embodiments, a downhole information handling system (not illustrated) comprises additional components, e.g., memory, input/output devices, interfaces, and the like. In certain embodiments, BHA 130 includes one or more additional components, e.g., an analog-to-digital converter, filter, and amplifier, used to process the measurements of BHA 130 before they are transmitted to surface 108. In certain embodiments, raw measurements from BHA 130 are transmitted to surface 108.

Any suitable technique may be used for transmitting signals from BHA 130 to surface 108, including, but not limited to, wired pipe telemetry, mud-pulse telemetry, acoustic telemetry, and electromagnetic telemetry. In certain embodiments, BHA 130 includes a telemetry subassembly used to transmit telemetry data to surface 108. In certain embodiments, the telemetry data is analyzed and processed by information handling system 138.

Communication link 140, which may be wired or wireless, transmits information between BHA 130 to an information handling system 138 at surface 108. In certain embodiments, information handling system 138 includes one or more of a personal computer 141, a video display 142, an input devices, e.g., keyboard 144 and a non-transitory computer-readable media 146, e.g., optical disks and magnetic memory, that store code representative of the methods described herein.

In certain embodiments, methods disclosed herein are utilized by information handling system 138 to determine properties of subterranean formation 106. In certain embodiments, information is utilized to produce an image that is used to generate a two or three-dimensional model of subterranean formation 106. In certain embodiments, this model is used for well planning, e.g., selecting a desired path of borehole 102, or planning the placement of drilling systems within a prescribed area.

During drilling operations, measurements taken within borehole 102 may be used to adjust the geometry of borehole 102 in real time to reach a geological target. In certain embodiments, measurements collected from BHA 130 of the formation properties are used to steer drilling system 100 toward a particular bed of the subterranean formation 106.

The processing may be performed real-time during data acquisition or after recovery of BHA 130. For this disclosure, real-time is a duration of time ranging from about a second to about ten minutes. Processing may occur downhole or may occur both downhole and at surface. Information handling system 138 may process the signals, and the information contained therein may be displayed for an operator to observe and store for future processing and reference. Information handling system 138 may also contain an apparatus for supplying control signals and power to BHA 130.

Systems and methods of the present disclosure may be implemented, at least in part, with information handling system 138. While shown at surface 108, information handling system 138 may also be located at another location, such as remote from borehole 102. Information handling system 138 may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. In certain embodiments, the information handling system 138 comprises one or more of a personal computer 141, a network storage device, a random access memory (RAM), a central processing unit (CPU) or equivalent hardware, read-only memory (ROM), and/or other types of nonvolatile memory. In certain embodiments, the information handling system 138 comprises one or more of a disk drive, a network port for communication with external devices as well as various input and output (I/O) devices, e.g., a keyboard 144 or a mouse or a video display 142. In certain embodiments, video display 142 provides an image to a user based on activities performed by personal computer 141. In certain embodiments, images of geological structures are created from recorded signals. In certain embodiments, video display unit produces a plot of depth versus the two cross-axial components of the gravitational field and versus the axial component in borehole coordinates. The same plot may be produced in coordinates fixed to the Earth, such as coordinates directed to the North, East and directly downhole (vertical) from the point of entry to the borehole. A plot of overall (average) density versus depth in borehole or vertical coordinates may also be provided. A plot of density versus distance and direction from the borehole versus vertical depth may be provided. It should be understood that many other types of plots are possible when the actual position of the measurement point in North, East and vertical coordinates is taken into account. Additionally, hard copies of the plots may be produced in paper logs for further use.

In certain embodiments, systems and methods of the present disclosure are implemented, at least in part, with non-transitory computer-readable media 146. Non-transitory computer-readable media 146 may include any instrumentality or aggregation of instrumentalities that may retain data and/or instructions for a period of time. Non-transitory computer-readable media 146 may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing.

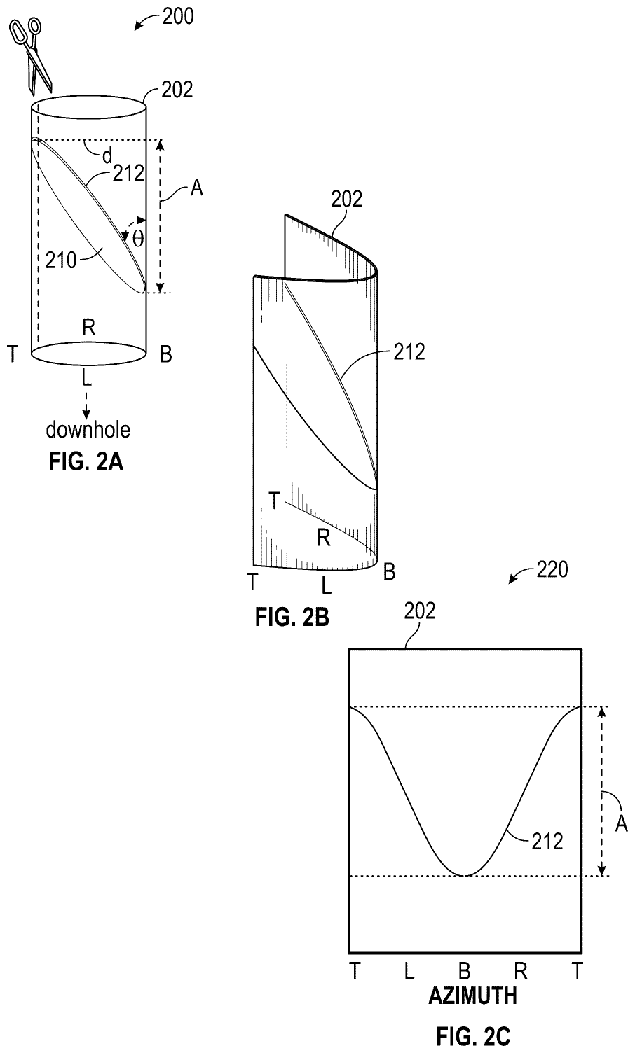

FIG. 2A illustrates an azimuthal wellbore image 202 wherein a 3D bed boundary 210, defined as the interface between two formation beds 154 of FIG. 1 through which the wellbore passes, is mapped onto the image 202 as an ellipse 212. result from the unrolling of this cylinder. The wellbore 202 has a diameter “d” and the angled plane 210 has a height “A” in the direction of the wellbore axis. Any planar event crossing the borehole results approximately on a one period sinusoid trace on the unrolled image. In reality, the bed boundary 210 is not a flat plane but, for the purposes of dip picking, is treated as a flat plane within the bounds of the wellbore 200.

FIG. 2B depicts the unrolling of the cylindrical azimuthal wellbore image 202, conceptually cutting along the dashed line with metaphorical scissors at the azimuthal reference “T” as shown in FIG. 1. The ellipse 212 is now a curved line 212 on the curved plane of the image 202.

FIG. 2C depicts a plot 220 of the cylindrical azimuthal wellbore image 202 fully unrolled as a flat plane. The curved line 212 is now apparent as a sinusoidal line 212. The height, also referred to interchangeably as the magnitude, of the sinusoidal line 212 is still the height A from FIG. 2A. The horizontal axis of plot 220 is the apparent azimuth angle, with azimuthal references “T” for top, “L” for left, “B” for bottom, “and “R” for right are shown along the bottom of the plot 220. The vertical axis of plot 220 is the measured depth along the borehole trajectory. As soon as line 212 is extracted, the inclination, azimuth, and depth of the plane 212 can be directly determined.

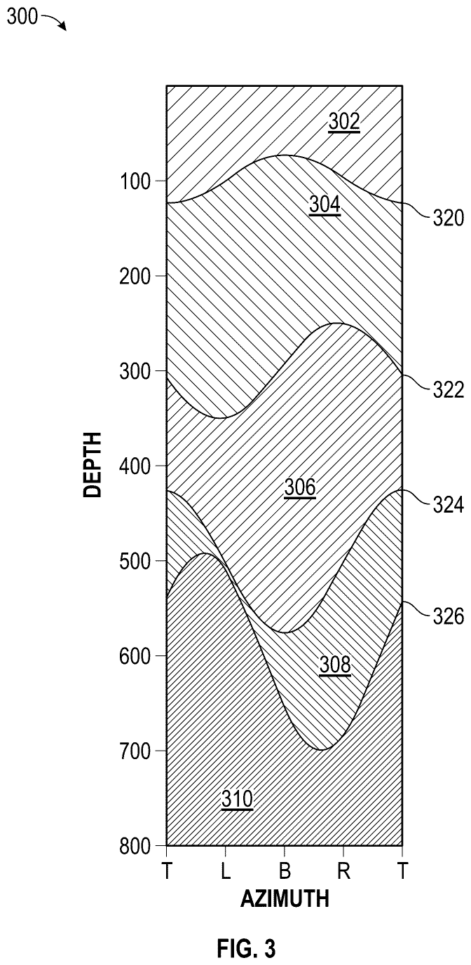

FIG. 3 illustrates beds and boundaries in an example formation 300, in accordance with various aspects of the subject technology. This view is an azimuthal wellbore image as explained in FIGS. 2A-2C. There are five beds 302, 304, 306, 308, 310 shown in this example formation 300. The boundaries 320, 322, 324, 326 separate adjacent beds are referred to herein as “dips.” Boundaries 320, 322 are considered “simple” dips as they are locally separated from the boundaries above and below. Boundaries 324, 326 are considered to be “complex” dips as a portion of boundary 324 is locally proximate to boundary 326, making it more difficult to determine the placement of the two dips 324, 326 in that region.

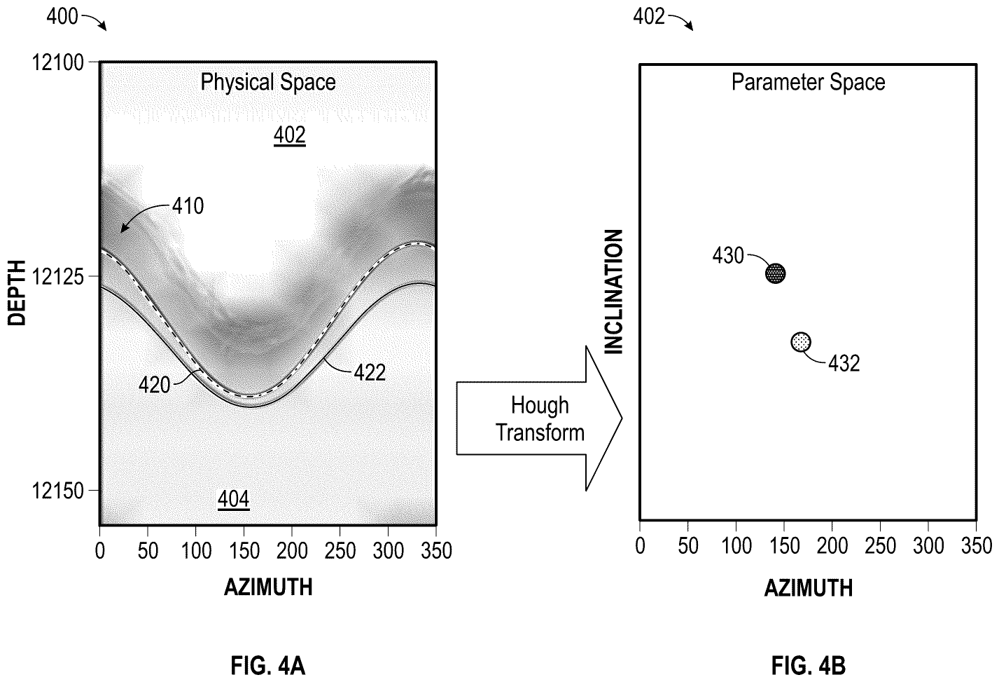

FIG. 4A illustrate an example of a boundary between beds 402, 404 and two dips 420, 422 manually selected by different individuals, in accordance with various aspects of the subject technology. The instrument readings from the sensing tool of the BHA, e.g., a resistivity tool, are presented as an azimuthal wellbore image in physical space 400. Wellbore images may be processed using various image analysis techniques, e.g., edge detection or gradient mapping. In certain embodiments, the azimuthal wellbore image is presented as different shades associated with values of the local gradient but no sharp transitions. The dips 420, 422 represent the best effort of a human to position a sinusoidal line along a transition between the beds 402, 404 and the intermediate bed 410. Each dip has a respective depth, a magnitude, which is equivalent to the inclination of a plane intersecting the wellbore, and an azimuth, e.g., the angular direction of the lowest point of the sine wave.

Hough transform is a feature-extraction technique widely used to detect structures such as lines, ellipses, or sinusoids within a cluttered image or with partial data. The original Hough transform was concerned with the identification of straight lines in the image, but the technique was later extended to identifying positions of arbitrary shapes, most commonly circles or ellipses. In practice, the parameter space is selected according to the shape to be detected. In this application, the parameter space is selected to detect sinusoidal lines.

In a Hough transform of a digital image, each pixel casts votes for the features compatible with its value and coordinates, as is known to those of skill in the art. The votes of all the pixels are accumulated in the parameter space of the sought structure. Then, maxima in this transformed space are used to extract candidate structures. One drawback of applying the Hough transform for an entire azimuthal wellbore image is the computational cost in time and/or processing power.

[There appear to be 2 point of novelty of this invention over known fully automatic dip methods and fully manual dip methods: (1) performing the Hough transform on only a portion of the full azimuthal wellbore image, and (2) using a manual pick as a starting point for an automatic process.

FIG. 4B illustrate an example of mapping the dips 420, 422 from the physical space 400 into a parameter space 402 using a Hough transform, in accordance with various aspects of the subject technology. In a properly selected model, a sinusoidal line maps to a single point in a 3D parameter space, e.g., depth, inclination, and azimuth, although only two dimensions (inclination and azimuth) are shown in FIG. 4B for simplicity. In this example, dip 420 maps to point 430 and dip 422 maps to point 432. In this 2D view of the example parameter space, it is easily determined that point 430, associated with dip 420, has a larger inclination than point 432, associated with dip 422. It is also apparent that the dips 420, 422 are associated with planar boundaries oriented at slightly different azimuthal directions.

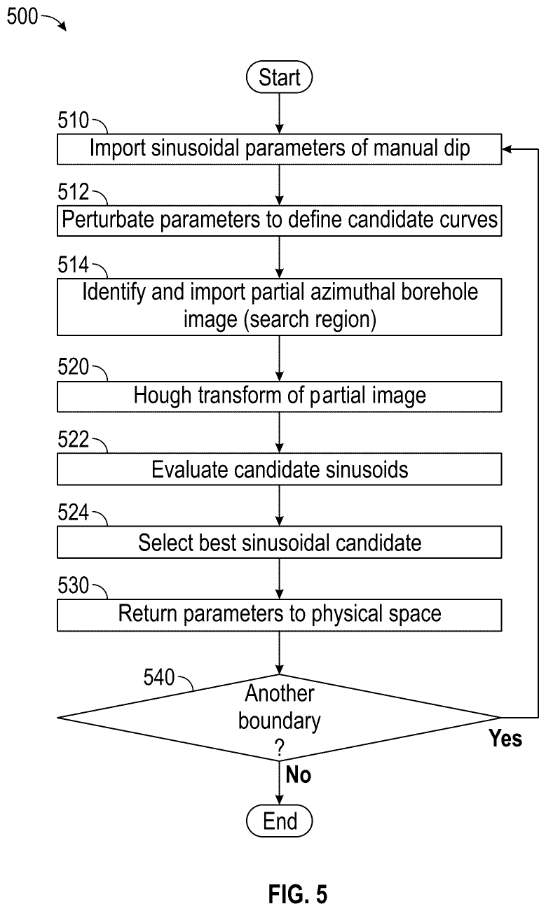

FIG. 5 is a flowchart 500 of an exemplary process for automatically assisting in mapping a dip, in accordance with various aspects of the subject technology. While conventional automatic dip picking systems start without human input, the disclosed systems and methods use a manual dip pick and then automatically refine the dip pick to improve consistency and accuracy. Furthermore, the disclosed systems and methods reduce the computational load, compared to conventional fully automatic dip picking that incrementally analyzes the entire azimuthal wellbore image, by determining a reduced portion of the azimuthal wellbore image that contains sufficient information to complete the enhancement of the initial manual dip pick. The reduced computational load enables performing the enhancement of an initial manual pick fast enough to be useful while drilling a well, i.e., in near real time.

The process starts with step 510, in which the manually selected values of the physical parameters, e.g., a depth in the wellbore, a height or magnitude of the sinusoid, and an azimuthal direction, associated with a manual dip of an azimuthal wellbore image are imported into a processor. Step 512 perturbates these values according to user-selected parameters. In certain embodiments, step 512 selected a plurality of sets of values to generate respective candidate sinusoidal curves. In certain embodiments, the perturbation is a random selection within a range of +/−5% of the manually selected value, the range centered around the selected value. In certain embodiments, the range is +/−1%, +/−2%, +/−3%, +/−4%, +/−10%, +/−15%, +/−20%, +/−25%, or +/−50%, or any other value. In certain embodiments, the range is not symmetric about the manually selected value, e.g., the range is −0/+5%. In certain embodiments, the perturbation is performed by selecting values according to a probability model, e.g., a uniform distribution or a Gaussian distribution, from within the range.

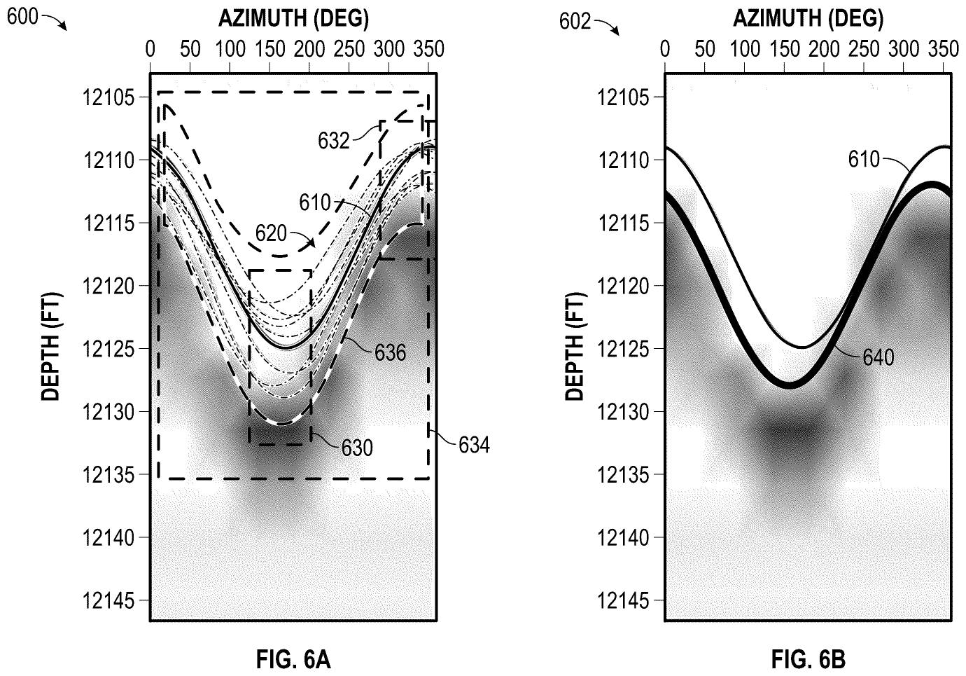

In certain embodiments, the perturbated parameters are used to select a limited depth range of the wellbore image, for example region 634 of FIG. 6.

Step 514 evaluates the candidate curves associated with the perturbated values of the physical parameters and selects one or more portions of the azimuthal wellbore image as sufficiently representative of the image. In certain embodiments, the selected portion includes a local minimum of all the candidate curves. In certain embodiments, the selected portion includes a local maximum of all the candidate curves. In certain embodiments, the perturbated parameters are used to determine which pixels of the wellbore image are covered and return those pixels only. In certain embodiments, the return pixels are a sinusoidal “band” shape such as area 636 of FIG. 6. In certain embodiments, the selected portion includes two or more discontinuous portions of the azimuthal wellbore image, taking advantage of the ability of a Hough transform to work with incomplete data. Step 514 then imports the selected portion of the azimuthal wellbore map into the processor.

Step 520 transforms only the selected portion of the image using the Hough transformation. As the time to perform the Hough transform is proportional to the area of the image, processing only a fraction of the image will increase the speed of the process by the inverse amount. A reduction in processing time of 10-100× has been found to be feasible.

Step 522 evaluates the points in the parameter space. In certain embodiments, the evaluation comprises comparing the number of votes received by each point in the parameter space from pixels in the physical space, which is discussed further with respect to FIGS. 6A-6B. In certain embodiments, the evaluation comprises evaluating a dip score that can quantitatively determine whether a dip pick is good or bad. The possible dip score may be symmetry, contrast, and uncertainty. In certain embodiments, the evaluation comprises evaluating an overall dip score computing from a variety of dip scores. In step 524, the local maxima of the comparison metric is identified. In certain embodiments, the point having highest number of votes from physical space pixels is selected.

Step 530 returns the value of the physical parameters associated with the selected point in parameter space. If the manually selected dip for a different boundary is to be evaluated, the process 500 clears the data and loops back to step 510 from decision point 540, otherwise proceeds to the process end.

FIG. 6A illustrate the step of identifying candidate sinusoids 620 in physical space, in accordance with various aspects of the subject technology. The plot 600 is the azimuthal wellbore image with the manual pick 610 superimposed. A plurality of candidate curves 620 are shown, each curve associated with a respective set of perturbed values of the physical parameters.

In certain embodiments, a reduced region 634 is selected that includes the full width (circumference) of the image and a reduced vertical region. In certain embodiments, a shaped area 636 that generally matches the shapes of curves 620 and encompasses the curves 620 is selected. In certain embodiments, evaluation of one or more characteristics of the plurality of curves enables the selection of a reduced area of the azimuthal wellbore image as a portion 630, e.g., an area that includes the minima of each curve and the local gradient of the image. In certain embodiments, a second portion 632 is selected as well, e.g., to capture the maxima of each curve. In certain embodiments, other positions and sizes of portions of the image are selected to provide the minimum necessary information to successfully differentiate between matches of the candidate curves 620 and the azimuthal wellbore image.

FIG. 6B illustrates an example refined curve selected by evaluation of the points of the parameter space. Each pixel in the physical space votes for a point based on whether the curve associated with that point passes through the pixel. A pixel in physical space will map to a curve in the parameter space, referred to herein as a “trace,” and a pixel votes for each point along the respective trace in parameter space. Each point in parameter space receives a vote for each trace that passes through that point. The point with the highest cumulative number of votes is associated with a physical space sinusoidal line that passes through the largest number of pixels, i.e., the “best” dip.

As is known by those of skill in the art, the Hough transform crequires that the physical image be pre-processed, for example to detect edges or gradients as well as optionally filtering the image to remove discontinuities and/or noise. In the example of FIG. 6B, the raw wellbore measurements are converted to an intensity or vale for each pixel and then further processed to determine the gradient at each pixel.

In certain embodiments, the “vote” by each pixel is weighted by the gradient of the measurement in the physical space. When the value of the measured characteristic, e.g., the resistivity, of a first bed is different from the value of an adjacent bed, there will be a gradient at the boundary between the two beds. In certain embodiments, a pixel that is positioned at the highest gradient, e.g., the fastest transition from one bed to the adjacent bed, will have a greater weight than a pixel having a low gradient, e.g., a pixel away from the boundary. In this way, the high-gradient pixels have the strongest influence on selection of the refined curve.

In certain embodiments, the azimuthal wellbore image is filtered to select pixels having a characteristic, e.g., a gradient value, above a threshold. Only selected pixels vote, thus weighting the voting by the proximity of the pixel to the boundary as well as reducing the computation load in the Hough transform.

Curve 640 is the output of step 530 of flowchart 500, with the manually selected curve 610 shown for comparison. Curve 640 is visually a closer latch to the boundary gradient of the underlying azimuthal wellbore image, as desired.

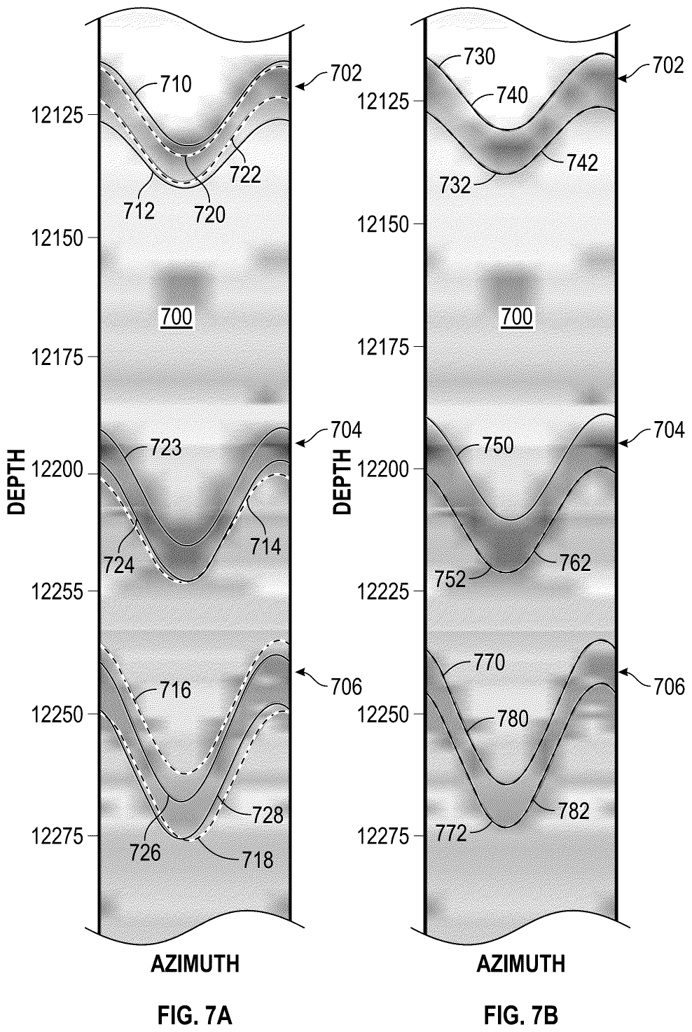

FIGS. 7A-7B illustrate experimental results of improvements from manually picked dips to an automatically refined dip, in accordance with various aspects of the subject technology.

FIG. 7A depicts a field-data formation 700 overlaid with dips manually picked by two skilled individuals. Dips 710,720 are manually selected dips for the upper boundary of bed 702. Dips 712,722 are manually selected dips for the lower boundary of bed 702. Dip 723 is the manually selected dip for the upper boundary of bed 704. Dips 714, 724 are manually selected dips for the lower boundary of bed 704. Dips 716, 726 are manually selected dips for the upper boundary of bed 706. Dips 718, 728 are manually selected dips for the lower boundary of bed 706. Dips 710, 712, 714, 716, 718 were manually selected by the first individual. Dips 720, 722, 723, 724, 726, 728 were manually selected by the second individual.

In comparing the two manually selected dips for a given boundary, it can be seen that the dips are sometimes positioned at different depths in the wellbore, have a different azimuth, and different amplitudes/inclinations. It is not obvious, from visual inspection, that one of each pair is superior to the other.

FIG. 7B depicts the same formation 700 with the same beds 702, 704, 706 overlaid with the refined dips provided by the methods disclosed herein. While the refined curves, in some cases, appear to be closer to the gradient boundaries, it is difficult to visually assess the degree of accuracy for the same reason that it is difficult to manually pick a repeatable and accurate dip in the first place.

Table 1 presents the values of the various curves of FIGS. 8A-8B for a quantitative comparison. These values are taken from actual field data. Each of the individual manual dips was refined separately to generate the values in the “refined dip” columns.

TABLE 1
Manual & refined dip parameter values

| MANUAL DIP | | | | | | | |
|---|---|---|---|---|---|---|---|
| INDIVIDUAL #1 | | | | REFINED DIP | | | |
| CURVE# | DEPTH | AMPLITUDE | AZIMUTH | CURVE# | DEPTH | AMPLITUDE | AZIMUTH |
| 710 | 12123 | 8.90 | 167.8 | 740 | 12120 | 8.0 | 154.0 |
| 712 | 12133 | 7.12 | 160.2 | 742 | 12130 | 7.0 | 148.0 |
| 714 | 12211 | 11.30 | 157.2 | 762 | 12209 | 11.0 | 151.0 |
| 716 | 12248 | 13.87 | 161.6 | 780 | 12249 | 15.0 | 151.0 |
| 718 | 12262 | 13.52 | 167.8 | 782 | 12258 | 15.0 | 151.0 |
| INDIVIDUAL #2 | | | | | | | |
| CURVE# | DEPTH | AMPLITUDE | AZIMUTH | CURVE# | DEPTH | AMPLITUDE | AZIMUTH |
| 720 | 12124 | 9.30 | 162.1 | 730 | 12120 | 8.0 | 154.0 |
| 722 | 12130 | 8.92 | 157.1 | 732 | 12130 | 7.0 | 148.0 |
| 723 | 12202 | 12.27 | 164.5 | 750 | 12198 | 11.0 | 160.0 |
| 724 | 12209 | 12.64 | 162.1 | 752 | 12209 | 11.0 | 151.0 |
| 726 | 12252 | 15.25 | 154.6 | 770 | 12249 | 15.0 | 151.0 |
| 728 | 12261 | 14.10 | 154.6 | 772 | 12258 | 15.0 | 151.0 |

Table 2 presents a comparison of the two manually selected dips and a comparison between the refined dips that were independently generated for each manual dip. The manual dips vary 1-4 ft for the wellbore depth, 4-20% in amplitude/inclination, and 3-13 degrees in azimuthal direction. The refined dips of each of the pairs of manual dips are effectively identical, illustrating the elimination of bias inherent in a manual dip.

TABLE 2
comparison of manual and refined dips

| | DIFFERENCE IN MANUAL DIPS | | | DIFFERENCE IN REFINED DIPS | | |
|---|---|---|---|---|---|---|
| CURVES | DEPTH | AMPLITUDE | AZIMUTH | DEPTH | AMPLITUDE | AZIMUTH |
| 710, 720 | 1 | 0.40 | 6.7 | 0 | 0 | 0 |
| 712, 722 | 3 | 1.80 | 3.1 | 0 | 0 | 0 |
| 714, 724 | 2 | 1.34 | 4.9 | 0 | 0 | 0 |
| 716, 726 | 4 | 1.38 | 5.0 | 0 | 0 | 0 |
| 718, 728 | 1 | 0.58 | 13.2 | 0 | 0 | 0 |

In summary, the systems and methods of refining a manual dip that are disclosed herein have been found to converge manual dips performed by different individuals to a single refined dip, or at least very similar refined dips, thus eliminating the variability and bias inherent in manual picking of a dip by humans. The refined dips are qualitatively better matches for the pattern of field data measurements of the azimuthal wellbore image.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In the above description, terms such as “upper,” “upward,” “lower,” “downward,” “above,” “below,” “downhole,” “uphole,” “longitudinal,” “lateral,” and the like, as used herein, shall mean in relation to the bottom or furthest extent of the surrounding wellbore even though the wellbore or portions of it may be deviated or horizontal. Correspondingly, the transverse, axial, lateral, longitudinal, radial, etc., orientations shall mean orientations relative to the orientation of the wellbore or tool. Additionally, the illustrate embodiments are illustrated such that the orientation is such that the right-hand side is downhole compared to the left-hand side.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or another word that substantially modifies, such that the component need not be exact. For example, substantially cylindrical means that the object resembles a cylinder, but can have one or more deviations from a true cylinder.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Claim language reciting “an item” or similar language indicates and includes one or more than one of the items. For example, claim language reciting “a part” means one part or multiple parts. Moreover, claim language reciting “at least one of” a set indicates that one member of the set or multiple members of the set satisfy the claim. For example, claim language reciting “at least one of A and B” means A, B, or A and B.

Aspects of the invention include the embodiments listed herein.

(A1) A method of refining manually selected values of physical parameters associated with a manual dip of an azimuthal wellbore image, the method comprising: perturbating one or more of the manually selected values; selecting a portion of the azimuthal wellbore image based in part on the perturbated values; performing a Hough transform of the selected portion of the azimuthal wellbore image into a parameter space comprising a plurality of points, thereby determining respective cumulative counts for one or more of the plurality of points in the parameter space; selecting a point based in part on its respective cumulative count; calculating refined values of the physical parameters associated with the selected point; and returning the refined values as the physical parameters of a refined dip.

(A2) The method of A1, further comprising: generating one or more candidate dips from the perturbated values; wherein: selecting the portion of the azimuthal wellbore image is based in part on the one or more candidate dips.

(A3) The method of A2, wherein the selected portion of the azimuthal wellbore image comprises at least one of a sinusoidal upper boundary and a sinusoidal lower boundary.

(A4) The method of A1, wherein: the parameter space is chosen to detect sinusoidal curves; and each point in the parameter space is uniquely associated with a respective set of physical parameters.

(A5) The method of A1, wherein: the plurality of physical parameters comprise a first depth, a first amplitude, and a first azimuth; and the parameter space is chosen to have dimensions comprising a second depth, a second amplitude, and a second azimuth.

(A6) The method of A5, wherein: perturbating the one or more of the manually selected values comprises perturbating a manually selected value of the first depth to define a depth range; and selecting the portion of the azimuthal wellbore image comprises retaining only the portion of the azimuthal wellbore image within the defined depth range.

(B7) A non-volatile memory comprising instructions that, when loaded into a processor and executed, cause the processor to perform steps: retrieving manually selected values of physical parameters associated with a manual dip of an azimuthal wellbore image; perturbating one or more of the manually selected values; selecting a portion of the azimuthal wellbore image based in part on the perturbated values; performing a Hough transform of the selected portion of the azimuthal wellbore image into a parameter space comprising a plurality of points, thereby determining a cumulative count at each point in the parameter space; selecting a point having a maximum cumulative count in the parameter space; calculating refined values of the physical parameters associated with the point; and returning the refined values as the physical parameters of a refined dip.

(B8) The memory of B7, wherein the steps further comprise: generating one or more candidate dips from the perturbated values; wherein: selecting the portion of the azimuthal wellbore image is based in part on the one or more candidate dips.

(B9) The memory of B8, wherein the selected portion of the azimuthal wellbore image comprises at least one of a sinusoidal upper boundary and a sinusoidal lower boundary.

(B10) The memory of B7, wherein: the parameter space is chosen to detect sinusoidal curves; and each point in the parameter space is uniquely associated with a respective set of physical parameters.

(B11) The memory of claim 7, wherein: the plurality of physical parameters comprise a first depth, a first amplitude, and a first azimuth; and the parameter space is chosen to have dimensions comprising a second depth, a second amplitude, and a second azimuth.

(B12) The memory of B11, wherein: perturbating the one or more of the manually selected values comprises perturbating a manually selected value of the first depth to define a depth range; and selecting the portion of the azimuthal wellbore image comprises retaining only the portion of the azimuthal wellbore image within the defined depth range.

(C13) A system, comprising: a processor; and a non-volatile memory coupled to the processor and comprising instructions that, when loaded into the processor and executed, cause the processor to perform steps: retrieving manually selected values of physical parameters associated with a manual dip of an azimuthal wellbore image; perturbating one or more of the manually selected values; selecting a portion of the azimuthal wellbore image based in part on the perturbated values; performing a Hough transform of the selected portion of the azimuthal wellbore image into a parameter space comprising a plurality of points, thereby determining a cumulative count at each point in the parameter space; selecting a point having a maximum cumulative count in the parameter space; calculating refined values of the physical parameters associated with the point; and returning the refined values as the physical parameters of a refined dip.

(C14) The system of C13, wherein the steps further comprise: generating one or more candidate dips from the perturbated values; wherein: selecting the portion of the azimuthal wellbore image is based in part on the one or more candidate dips.

(C15) The system of C14, wherein the selected portion of the azimuthal wellbore image comprises at least one of a sinusoidal upper boundary and a sinusoidal lower boundary.

(C16) The system of C13, wherein: the parameter space is chosen to detect sinusoidal curves; and each point in the parameter space is uniquely associated with a respective set of physical parameters.

(C17) The system of C13, wherein: the plurality of physical parameters comprise a first depth, a first amplitude, and a first azimuth; and the parameter space is chosen to have dimensions comprising a second depth, a second amplitude, and a second azimuth.

(C18) The system of C17, wherein: perturbating the one or more of the manually selected values comprises perturbating a manually selected value of the first depth to define a depth range; and selecting the portion of the azimuthal wellbore image comprises retaining only the portion of the azimuthal wellbore image within the defined depth range.

What is claimed is:

1. A method of refining manually selected values of physical parameters associated with a manual dip of an azimuthal wellbore image, the method comprising:
perturbating one or more of the manually selected values;
selecting a portion of the azimuthal wellbore image based in part on the perturbated values;
performing a Hough transform of the selected portion of the azimuthal wellbore image into a parameter space comprising a plurality of points, thereby determining respective cumulative counts for one or more of the plurality of points in the parameter space;
selecting a point based in part on its respective cumulative count;
calculating refined values of the physical parameters associated with the selected point; and
returning the refined values as the physical parameters of a refined dip.

2. The method of claim 1, further comprising:
generating one or more candidate dips from the perturbated values;
wherein:
selecting the portion of the azimuthal wellbore image is based in part on the one or more candidate dips.

3. The method of claim 2, wherein the selected portion of the azimuthal wellbore image comprises at least one of a sinusoidal upper boundary and a sinusoidal lower boundary.

4. The method of claim 1, wherein:
the parameter space is chosen to detect sinusoidal curves; and
each point in the parameter space is uniquely associated with a respective set of physical parameters.

5. The method of claim 1, wherein:
the plurality of physical parameters comprise a first depth, a first amplitude, and a first azimuth; and
the parameter space is chosen to have dimensions comprising a second depth, a second amplitude, and a second azimuth.

6. The method of claim 5, wherein:
perturbating the one or more of the manually selected values comprises perturbating a manually selected value of the first depth to define a depth range; and
selecting the portion of the azimuthal wellbore image comprises retaining only the portion of the azimuthal wellbore image within the defined depth range.

7. A non-volatile memory comprising instructions that, when loaded into a processor and executed, cause the processor to perform steps:
retrieving manually selected values of physical parameters associated with a manual dip of an azimuthal wellbore image;
perturbating one or more of the manually selected values;
selecting a portion of the azimuthal wellbore image based in part on the perturbated values;
performing a Hough transform of the selected portion of the azimuthal wellbore image into a parameter space comprising a plurality of points, thereby determining a cumulative count at each point in the parameter space;
selecting a point having a maximum cumulative count in the parameter space;
calculating refined values of the physical parameters associated with the point; and
returning the refined values as the physical parameters of a refined dip.

8. The memory of claim 7, wherein the steps further comprise:
generating one or more candidate dips from the perturbated values;
wherein:
selecting the portion of the azimuthal wellbore image is based in part on the one or more candidate dips.

9. The memory of claim 8, wherein the selected portion of the azimuthal wellbore image comprises at least one of a sinusoidal upper boundary and a sinusoidal lower boundary.

10. The memory of claim 7, wherein:
the parameter space is chosen to detect sinusoidal curves; and
each point in the parameter space is uniquely associated with a respective set of physical parameters.

11. The memory of claim 7, wherein:
the plurality of physical parameters comprise a first depth, a first amplitude, and a first azimuth; and
the parameter space is chosen to have dimensions comprising a second depth, a second amplitude, and a second azimuth.

12. The memory of claim 11, wherein:
perturbating the one or more of the manually selected values comprises perturbating a manually selected value of the first depth to define a depth range; and
selecting the portion of the azimuthal wellbore image comprises retaining only the portion of the azimuthal wellbore image within the defined depth range.

13. A system, comprising:
a processor; and
a non-volatile memory coupled to the processor and comprising instructions that, when loaded into the processor and executed, cause the processor to perform steps:
retrieving manually selected values of physical parameters associated with a manual dip of an azimuthal wellbore image;
perturbating one or more of the manually selected values;
selecting a portion of the azimuthal wellbore image based in part on the perturbated values;
performing a Hough transform of the selected portion of the azimuthal wellbore image into a parameter space comprising a plurality of points, thereby determining a cumulative count at each point in the parameter space;
selecting a point having a maximum cumulative count in the parameter space;
calculating refined values of the physical parameters associated with the point; and
returning the refined values as the physical parameters of a refined dip.

14. The system of claim 13, wherein the steps further comprise:
generating one or more candidate dips from the perturbated values;
wherein:
selecting the portion of the azimuthal wellbore image is based in part on the one or more candidate dips.

15. The system of claim 14, wherein the selected portion of the azimuthal wellbore image comprises at least one of a sinusoidal upper boundary and a sinusoidal lower boundary.

16. The system of claim 13, wherein:
the parameter space is chosen to detect sinusoidal curves; and
each point in the parameter space is uniquely associated with a respective set of physical parameters.

17. The system of claim 13, wherein:
the plurality of physical parameters comprise a first depth, a first amplitude, and a first azimuth; and
the parameter space is chosen to have dimensions comprising a second depth, a second amplitude, and a second azimuth.

18. The system of claim 17, wherein:
perturbating the one or more of the manually selected values comprises perturbating a manually selected value of the first depth to define a depth range; and
selecting the portion of the azimuthal wellbore image comprises retaining only the portion of the azimuthal wellbore image within the defined depth range.
